(19) United States
(12) Patent Application Publication
(10) Pub. No.: US 2003/0229169 A1
(43) Pub. Date: Dec. 11, 2003

(54) Polypropylene resin composition for automobile door trims having impact and scratch resistance

(76) Inventors: Kyung Sik Han, Ulsan-Si (KR); Seung Wook Hwang, Daejeon-Si (KR); Byung Soon Park, Ulsan-Si (KR)

Correspondence Address: Pennie & Edmonds, LLP, 3300 Hillview Avenue, Palo Alto, CA, 94304, US

(21) Appl. No.: 10/334,925

(22) Filed: Dec. 31, 2002

(30) Foreign Application Priority Data
Jun. 5, 2002 (KR) 2002-31702

(51) Int. Cl. C08K 5/04

(52) U.S. Cl. 524/400; 524/451; 524/425; 524/445; 524/423; 524/433; 524/449

(57) ABSTRACT

A polypropylene resin composition for automobile door trims having superior impact resistance, rigidity and scratch resistance, and more particularly, to a partially-crosslinked polypropylene resin composition prepared by adding highly-crystalline polypropylene, partially-crosslinked polypropylene, polyethylene, optionally an ethylene copolymer rubber, and an inorganic filler.

### FIELD OF THE INVENTION

The present invention relates to a polypropylene-based resin composition for automobile door trims having superior impact resistance, rigidity and scratch resistance, and more particularly to a composition prepared by adding highly-crystalline polypropylene, polyethylene and inorganic filler in a partially-crosslinked system to omit or reduce use of expensive rubbers, and to automobile door trims made thereof.

### BACKGROUND OF THE INVENTION

Automobile door trims are classified as a single-layer type (bare type) and a three-layer type (skin/foam/core). The single-layer type door trims, which are injection-molded from polypropylene adding rubber and inorganic filler, are mainly used for small automobiles. The three-layer type door trims, which have layers of PVC (polyvinyl chloride) skin, PP (polypropylene) foam and polypropylene core, are mainly used for medium or large automobiles. Materials having excellent impact resistance are required for automobile interiors, especially for instrument panels or door trims, with regard to collision regulations and driver/passenger protection regulations.

Among others, polypropylene materials used for single-layer type door trims require superior impact resistance, rigidity, heat resistance and scratch resistance to meet the collision test and regulations. However, aesthetic qualities are also important, and the impact resistance tends to be inversely proportional to the scratch resistance. Moreover, door trims require superior molding fluidity for fine detailss, for example molding grills of speakers, which limit the impact resistance.

In general, rubber with good impact resistance is added to polypropylene to improve the impact resistance of the blend. To attain the impact resistance required for automobile door trims, the art suggests that 5-15% of rubbers should be added. However, use of a large content of expensive rubbers is not only economically disadvantageous, but also impairs rigidity, heat resistance, and most of all, scratch resistance.

The scratch resistance is one of the most important requirements of door trims, which are handled by hands during production, transpiration and use of automobiles. The scratch resistance is typically determined by the pencil hardness test, which uses standard pencils, or the five finger test, which uses five balls with different loads. The pencil hardness test is adopted as standard in Korea, as in Japan.

Although the need in the industry is known for door trim resins having superior impact resistance and scratch resistance, there is no technique and/or formulation available as yet which offers superior impact resistance and scratch resistance required for door trims while also reducing the rubber content below about 5%. Development of such materials having superior impact resistance and scratch resistance required for automobile door trims, especially for single-layer door trims, are highly required.

### SUMMARY OF THE INVENTION

One object of this invention is to develop materials for door trims with superior impact resistance while reducing the rubber content, preferably below 5%, to prevent decrease in scratch resistance. The Korea Patent No. 0257835 by the present inventors discloses a polypropylene resin composition prepared by partially crosslinking polypropylene, which has good impact resistance, heat resistance and rigidity, is extrusion- and injection-moldable, and may have a variety of melt indices.

Surprisingly, a resin composition having superior scratch resistance and impact resistance required for automobile door trims can be formulated by replacing all or part of rubbers added to improve impact resistance of an olefin/rubber formulation, for example a polypropylene/rubber formulation discussed above, with partially-crosslinked polypropylene resin. Accordingly, an object of this invention is to provide a polypropylene resin composition comprising partially-crosslinked polypropylene and highly crystalline polypropylene for automobile door trims having superior impact resistance and scratch resistance.

### DETAILED DESCRIPTION OF THE INVENTION

This invention relates to a polypropylene resin composition for automobile door trims having superior impact resistance and scratch resistance, which contains:

(A) 1-70 parts by wt of highly-crystalline polypropylene resin;

(B) 10-70 parts by wt of partially-crosslinked polypropylene resin, which contains per 100 parts by wt of (B):

(a) 1-90 parts by wt of crystalline polypropylene resin, which comprises propylene monopolymer or copolymer of propylene and less than 10 mol% of C₂₋C₁₀ monomer, and has 0.1-3 g/10 min (230° C.) of melt index and higher than 300,000 g/mol of weight-average molecular weight;

(b) 10-99 parts by wt of polypropylene resin, which comprises copolymer of propylene and 11-25 mol% of at least one C₂-C₁₀ monomer, and has 10-60 g/10 min (230° C.) of melt index;

(c) 0-10 parts by wt of a crosslinking agent; and

(d) 0.01-2.0 parts by wt of initiator, for example an organic peroxide;

(C) 5-30 parts by wt of polyethylene;

(D) 0-10 parts by wt of thermoplastic elastic rubber; and

(E) 5-30 parts by wt of an inorganic filler.

Hereunder is given a more detailed description of this invention.

This invention relates to a highly-crystalline polypropylene resin composition for automobile door trims containing partially-crosslinked polypropylene, wherein the rubber content is reduced and polyethylene is added instead to improve tensile strength, rigidity and flexural strength, and to lower specific gravity to reduce weight. As used herein, polymeric compositions are characterized by the parts by weight of reactants that are put into the polymeric composition, wherein the number of parts is typically around 100, and is usually 100. Therefore, the term “parts” is generally synonymous with the term “percent by weight”. It is recognized that one or more of the ingredients may lose its identity or may be lost during the processing and/or during subsequent aging of the polymeric product, for example by partially reacting with other components or by losing semivolatile materials. The properties of the composition are generally measured on the composition after mixing and curing. Hereunder is given a more specific description of each ingredient of the polypropylene resin composition.

(A) Highly-Crystalline Polypropylene Resin

The highly-crystalline polypropylene resin, which is also called HCPP (High Crystallinity PolyPolypropylene), HIPP (High Isotacticity PolyPropylene) or HSPP (High Stiffness PolyPropylene), is added as a base instead of polypropylene to improve impact resistance, hardness and scratch resistance. Because the ingredient (A) has higher crystallinity compared with the conventional isotactic polymer, it has an improved rigidity of about 20-40%, heat resistance, scratch resistance and impact resistance. The highly-crystalline polypropylene can be used for automobile interior and exterior materials. And, most of all, it can be used, as compared with polypropylene, when higher rigidity and heat resistance are required. In some embodiments the inorganic filler content is reduced to lower the specific gravity of a blend containing highly-crystalline polypropylene. It is recommended to use the ingredient (A) to reduce the rubber content and improve scratch resistance.

The highly-crystalline polypropylene resin (A) is recommended to be propylene monopolymer or copolymer of propylene and less than about 10 mol% of C₂-C₁₀ monomer. The melt index of the polypropylene resin is recommended to be 8-60 g/10 min (230° C.). While the stereoregular isotactic index (II) of the currently available polypropylene is 94-97%; that of the polypropylene of this invention is higher than 98.5%, for example 99% or higher. If the isotactic index is high, the crystallinity of the polypropylene increases, which offers superior mechanical property and heat resistance to the polypropylene.

The highly-crystalline polypropylene resin (A) is used in 1-70 parts by wt for 100 wt % of the total composition. If the highly-crystalline polypropylene resin (A) content is outside this range, the rubber content cannot be reduced and the scratch resistance cannot be improved. In one embodiment, the highly-crystalline polypropylene resin (A) is present in an amount between about 20% and about 60%.

In another embodiment, the highly-crystalline polypropylene resin (A) is present in an amount between about 20% and about 60%, and the total of the highly-crystalline polypropylene resin (A) and the partially-crosslinked polypropylene resin (B) is between about 65% and about 75%.

(B) Partially-Crosslinked High-Impact Polypropylene Resin

The partially-crosslinked resin functions as impact reinforcing agent like rubber or elastomer, through structural modification of crosslinkage. The higher the molecular weight of this partially-crosslinked system, the more it tends to be crosslinked. And, the decomposition of the crystalline polypropylene in the partially-crosslinked system is regulated by decomposition temperature(s) (usually expressed as a half-life temperature) of the reaction initiator(s), which can be one or more organic peroxides.

As stated, the partially-crosslinked high-impact polypropylene resin is actually a pre-mixture which in one embodiment is substantially reacted when admixed into the formulation of the present invention. In another embodiment, the premixture is not substantially reacted prior to admixing into the formulation of the present invention. By substantially reacted it is meant that at least about 80% of the reaction initiators initially present are reacted with the polymers in the pre-mixture. The premixture comprises, and advantageously consists essentially of, (a) crystalline polypropylene of a propylene monopolymer or copolymer of propylene and less than 10 mol% of C₂-C₁₀ monomer; (b) a copolymer of propylene and 11-25 mol% of at least one C₂-C₁₀ monomer, and has 10-60 g/10 min (230° C.) of melt index; (c) one or more crosslinking agents; and (d) one or more initiators, for example an organic peroxide. In particular, the resin comprises:

(a) between about 1 and about 90 parts by wt, for example between about 20 and 70 parts by weight, of crystalline polypropylene resin which advantageously has 0.1-3 g/10 min (230° C.) of melt index and higher than 300,000 g/mol of weight-average molecular weight;

(b) between about 10 and about 99 parts by wt, for example between about 30 and 70 parts by weight, of a copolymer of propylene and 11-25 mol% of at least one C₂ or C₄-C₁₀ monomer (herein called “C₂-C₁₀,” where it is understood that propylene monomer is not included) and has 10-60 g/10 min (230° C.) of melt index;

(c) 0-10 parts by wt, for example about 2 to about 8 parts by wt. of a crosslinking agent; and

(d) 0.01-2.0 parts by wt, for example about 0.4 to about 1.6 parts by wt, of initiator, for example an organic peroxide. The parts by wt in the pre-mixture (B) are with reference to 100 parts by wt of the ingredient (B).

This crystalline polypropylene with a large weight-average molecular weight is mixed with polypropylene resin having a high α-olefin comonomer content and superior fluidity, and monomers of styrene, methacrylate, ethacrylate, vinyl ether or vinyl ester derivatives used alone or together as crosslinking agent, together with organic peroxide initiators advantageously having different decomposition temperatures. The partially crosslinked polypropylene resin composition has superior impact resistance, heat resistance and rigidity, and a variety of fluidity required for extrusion-molding or injection-molding can be obtained from extrusion.

Because such partially-crosslinked system has superior impact resistance and rigidity in itself, use of rubbers to increase the impact resistance can be reduced. Moreover, if polyethylene is added, the rubber content can be much reduced, so that impact resistance and rigidity required for automobile door trims can be obtained without using rubbers. Also, the scratch resistance becomes superior because the rubber content is low. This partially-crosslinked high-impact polypropylene is recommended to comprise (a), (b), (c) and (d).

Hereunder is given a more detailed description about each ingredient.

The ingredient (a) is a high-molecular-weight polypropylene, comprising propylene monopolymer or copolymer of propylene and C₂-C₁₀ monomer. Said C₂-C₁₀ monomer is recommended to be used in less than 10 mol%. The ingredient (a) is recommended to have 0.1-3 g/10 min (230° C.) of melt index and larger than 300,000 g/mol, more preferably 500,000 g/mol, of weight-average molecular weight.

For the ingredient (b), polypropylene having a large high-flow C₂-C₁₀ monomer content, which has superior fluidity and crosslinkage may from in the C₂-C₁₀ monomer region, is used. The C₂-C₁₀ monomer content is recommended to be 11-25 mol%, more preferably 15-25 mol%. And, the melt index is recommended to be 10-60 g/10 min (230° C.), more preferably 20-60 g/10 min.

The crosslinking agent (c) prevents decomposition of polypropylene during crosslinkage and promotes the crosslinking reaction. For the crosslinking agent, a polymerizable monomer can be used. In a preferred embodiment, styrene, α-methylstyrene, methyl methacrylate, ethyl methacrylate, cyclohexyl methacrylate, phenyl methacrylate, benzyl methacrylate, glycidyl methacrylate, methyl acrylate, ethyl acrylate, cyclohexyl acrylate, phenyl acrylate, benzyl acrylate, butyl acrylate, glycidyl acrylate, vinyl acetate, vinyl benzoate, methyl vinyl ether, ethyl vinyl ether, propyl vinyl ether and/or butyl vinyl ether can be used. Of these, it is recommended to use acrylate or methacrylate derivatives together with styrene derivatives. The ingredient (c) is used in less than 10 parts by wt with reference to 100 parts by wt of the ingredient (B). If its content exceeds 10 parts by wt, the fluidity control becomes difficult due to excessive crosslinkage.

The compound (d) functions as reaction initiator. In one preferred embodiment, one or more organic peroxides function as reaction initiator. For the organic peroxide, benzoyl peroxide, lauryl peroxide, dicumyl peroxide, bis(t-butylperoxyisopropyl)benzene, 2,5-dimethyl-2,5-di(t-butylperoxy)hexane and/ or 2,5-dimethyl-2,5-di(t-butylperoxy)hexane-3 can be used. It is better to use the ones having high and low half-life temperature together for fluidity control. This is because the organic peroxide having low decomposition temperature does not decompose well and it has low crosslinkage efficiency, and the one having high decomposition temperature decomposes excessively.

The ingredient (B) is used in 10-70 parts by wt with reference to 100 parts by wt of the total composition. If its content is outside this range, the rubber content cannot be reduced. In one embodiment, the partially-crosslinked polypropylene resin is used in an amount between about 10 and about 50 parts by weight.

In another embodiment, the partially-crosslinked polypropylene resin is used in an amount between about 10 and about 50 parts by weight, and the total of the highly-crystalline polypropylene resin (A) and the partially-crosslinked polypropylene resin (B) is between about 65% and about 75%.

(C) Polyethylene

Because polyethylene has superior cold resistance and is a good barrier against water and moisture, it is widely used for a variety of films. Also, because it improves impact resistance when used together with polypropylene, it can replace rubbers. Polyethylene can be classified as HDPE (high-density polyethylene), LDPE (low-density polyethylene) and LLDPE (linear low-density polyethylene), according to density. Among these, the high-density polyethylene having superior hardness is advantageous for products requiring good scratch resistance. The ingredient (C) is used in 5-30 parts by wt with reference to 100 parts by wt of the total composition. If the content falls outside this range, the required hardness and scratch resistance cannot be attained. In one embodiment, the polyethylene resin is used in an amount between about 5 and about 20 parts by weight. A preferred polyethylene has a melt index of about 3 to about 15, for example about 7 g/10 min and a 0.96 specific gravity.

(D) Thermoplastic Elastic Rubbers

The thermoplastic elastic rubbers are used to improve impact resistance. For the thermoplastic elastic rubbers, copolymers of ethylene and C₂-C₁₀ α-olefin can be used. The α-olefin may be propylene, butene, pentene, hexene, propene or octane, but it is not limited to such substances. Exemplary copolymer rubbers include EPR (ethylene-propylene rubber), EPDM (ethylene-propylene-diene rubber), EOR (ethylene-octene copolymer) and SBR (styrene-butadiene). Among these, EOR (ethylene-octene copolymer) is the most recommended because its octane group in the long side chain highly improves impact resistance while minimizing decrease of rigidity. For the ethylene-octene copolymer, the one having 10-39 wt %, more preferably 23-25 wt %, of octene content, 0.5-8 g/10 min (190° C., 2.6 kgf) of melt index, and 0.868-0.885 g/cc of density is recommended. Such rubbers are available, for example, in the Elastomer's Engage™ series from DuPont-Dow. The ethylene-α-olefin copolymer rubber is used in less than 10 parts by wt. If its content exceeds 10 parts by wt, it is difficult to attain superior scratch resistance and the cost will be also much increased. Advantageously, the ethylene-α-olefin copolymer rubber is used in less than about 5 parts by wt, for example less than 4 parts by weight, and in one embodiment less than 1 part, i.e., zero parts by wt.

(E) Inorganic Filler

The inorganic filler is used to improve heat resistance and rigidity. In a preferred embodiment, the inorganic filler includes one or more of talc, calcium carbonate, calcium sulfate, magnesium oxide, calcium stearate, wollastonite, mica, silica, calcium silicate, clay and carbon black can be used. Of these, wollastonite and talc are recommended. For the inorganic filler, the one that offers distinct increase in rigidity and hardness of the composition is recommended. Most preferably, talc having an average particle size of 1-30 μm, more preferably 5-10 μm, is recommended. The ingredient (E) is used in 5-30 parts by wt with reference to 100 parts by wt of the total composition. If the content falls outside this range, it is hard to improve heat resistance and rigidity. In one embodiment, the partially-crosslinked polypropylene resin is used in an amount of about 15 parts by weight.

Hereunder is given a more detailed description of this invention using Examples and Comparative Examples. The examples are to be illustrative of this invention and should not be construed as limiting the scope of this invention.

The physical property test was performed by the following methods.

1) The melt index was tested by ASTM D-1238. The test condition was 230° C. and 2.16 kgf.

2) The flexural modulus and flexural strength were tested by ASTM D-790. The test sample size was 12.7×127×6.4 mm, and the crosshead speed at the test condition was 28 mm/min.

3) The Izod impact resistance was tested by ASTM D-256. The test sample size was 63.5×12.7×3 mm.

4) The thermal deformation temperature was tested by ASTM D-648. The test sample size was 12.7×127×6.4 mm, and the load at the test condition was 4.6 kgf.

5) The pencil hardness was tested by JIS K-6301. Uni pencils (Mitsubishi, Japan) were used, and the testing speed was 10 mm/20s.

### EXAMPLES 1-5

Ingredients (A), (B), (C), (D) and (E) were put in a Hansell mixer and mixed for 3 min in the amounts shown in Table 1. The mixture was extruded with an extruder at 190-250° C. Then, it was cooled and solidified to obtain a pelletized composition. The compositions were injected at 180-250° C. according to their melt indices. Physical properties were determined by said methods and the result is shown in Table 1.

### EXAMPLES 6-7

The procedure of Example 1 was followed while changing contents of the ingredients (B) and (C) and excluding the ingredient (D), as shown in Table 1. Physical properties were determined by said methods and the result is shown in Table 1.

### COMPARATIVE EXAMPLES 1-2

The procedure of Example 1 was followed while excluding the ingredients (B) and (C), as shown in Table 1. Physical properties were determined by said methods and the result is shown in Table 1.

TABLE 1

| | | | | | | | | Izod Impact Resistance | | | | |
|---|---|---|---|---|---|---|---|---|---|---|---|---|
| | | Ingredient (wt %) | | | | | | (kgfcm/cm) | | Flexural | Thermal | Pencil |
| | | A | B | C | D | E | Melt Index | 23 ° C. | −10 ° C. | Modulus | Deformation | Hardness |
| Examples | 1 | 60 | 10 | 5 | 10 | 15 | 25.7 | 14.0 | 6.0 | 19,800 | 133° C. | 4 B |
| | 2 | 50 | 20 | 5 | 10 | 15 | 25.0 | 11.8 | 5.1 | 19,100 | 132 | 4 B |
| | 3 | 40 | 30 | 5 | 10 | 15 | 24.2 | 12.0 | 5.3 | 18,700 | 130 | 3 B |
| | 4 | 30 | 40 | 10 | 5 | 15 | 24.9 | 11.5 | 4.5 | 19,200 | 131 | 3 B |
| | 5 | 30 | 45 | 15 | 5 | 15 | 23.8 | 11.8 | 5.1 | 18,500 | 128 | 2 B |
| | 6 | 20 | 50 | 15 | — | 15 | 25.7 | 11.0 | 4.8 | 19,500 | 130 | 2 B |
| | 7 | 25 | 40 | 20 | — | 15 | 25.2 | 10.6 | 4.8 | 21,600 | 134 | 2 B |
| Comparative | 1 | 80 | — | — | 5 | 15 | 29.5 | 7.5 | 4.0 | 20,800 | 135 | 3 B |
| Examples | 2 | 75 | — | — | 10 | 15 | 27.6 | 11.2 | 5.1 | 19,500 | 132 | 5 B |

(Note)
A: Highly-crystalline polypropylene resin having 35 g/10 min (230□, 2.16 kgf) of melt index, 99% of isotactic index and 6 mol % of ethylene content
B: Partially-crosslinked impact-resistant polypropylene resin having 30 g/10 min of melt index, crosslinked by crosslinking agent and organic peroxide
C: High-density polyethylene having 7.0 g/10 min of melt index and 0.96 of specific gravity
D: Ethylene-octene copolymer having 25% of octene content and 0.5 g/10 min (190□, 2.16 kgf) of melt index
E: Talc having 18.5 μm of average particle size and 0.1% of post-composition weight reduction

As explained above, the resin composition for automobile door trims according to this invention, prepared by adding highly-crystalline polypropylene, high-density polyethylene and an inorganic filler in partially-crosslinked crystalline polypropylene resin, has a variety of fluidity properties and superior scratch resistance. Also, it has excellent rigidity and impact resistance required for automobile door trims by using only a small amount of expensive rubber.

Examples 1, 2, and 3 exhibited higher izod impact values at both ambient and at −10° C. than did the comparative examples.

What is claimed is:

1. A polypropylene resin composition for automobile door trims having superior impact resistance and scratch resistance, which contains:
(A) 1-70 parts by wt of highly-crystalline polypropylene resin;
(B) 10-70 parts by wt of partially-crosslinked polypropylene resin, which contains:
(a) 1-90 parts by wt of crystalline polypropylene resin, which comprises propylene monopolymer or copolymer of propylene and less than 10 mol% of C₂-C₁₀ monomer, and wherein the crystalline polypropylene resin has a melt index of 0.1-3 g/10 min (230° C.) and higher than 300,000 g/mol of weight-average molecular weight;
(b) 10-99 parts by wt of polypropylene resin, which comprises copolymer of propylene and 11-25 mol% of C₂-C₁₀ monomer, and has 10-60 g/10 min (230° C.) of melt index;
(c) 0-10 parts by wt of a crosslinking agent; and
(d) 0.01-2.0 parts by wt of organic peroxide;
(C) 5-30 parts by wt of polyethylene;
(D) 0-10 parts by wt of thermoplastic elastic rubber; and
(E) 5-30 parts by wt of an inorganic filler.

2. The polypropylene resin composition according to claim 1, wherein said highly-crystalline polypropylene resin (A) is propylene monopolymer or copolymer of propylene and less than 10 mol% of C₂-C₁₀ monomer, having melt index of 8-60 g/10 min (230° C.) and of isotactic index of higher than 98.5%.

3. The polypropylene resin composition according to claim 1, wherein said polyethylene (C) is high-density polyethylene.

4. The polypropylene resin composition according to claim 1, wherein said thermoplastic elastic rubber (D) is selected from ethylene-propylene rubber), ethylene-propylene-diene rubber), ethylene-octene copolymer rubber, styrene-butadiene rubber, or mixture thereof.

5. The polypropylene resin composition according to claim 1, wherein said inorganic filler (E) is at least one selected from talc, calcium carbonate, wollastonite, calcium sulfate, magnesium oxide, calcium stearate, mica, calcium silicate, clay and carbon black.

6. An automobile door trim, said automobile door trim being made of a resin comprising, based on 100 parts total:
(A) between 1 and about 70 parts by wt of highly-crystalline polypropylene resin consisting of propylene monopolymer, a copolymer of propylene and less than about 10 mol% of C₂-C₁₀ monomer, or mixture thereof, wherein the melt index of the highly-crystalline polypropylene resin is between 8 to 60 g/10 min (230° C.) and the isotactic index of the highly-crystalline polypropylene resin is higher than 98.5%;
(B) between 10 and 70 parts by weight of partially-crosslinked polypropylene resin, which contains the reaction product of:
(a) between 1 and 90 parts by weight of crystalline polypropylene resin, which comprises propylene monopolymer or copolymer of propylene and less than 10 mol% of C₂ and/or C₄-C₁₀ monomers, wherein the crystalline polypropylene resin has a melt index of 0.1 to 3 g/10 min (230° C.) and higher than 300,000 g/mol of weight-average molecular weight;
(b) between 10 and 99 parts by weight of copolymer resin consisting of copolymers of propylene and 11-25 mol% of C₂ and/or C₄-C₁₀ monomers, wherein the copolymer resin has a melt index of 10 to 60 g/10 min (230° C.);
(c) between 0 and 10 parts by weight of a crosslinking agent; and
(d) between 0.01 and 2 parts by weight of reaction initiator;
(C) between 5 and 30 parts by weight of polyethylene, wherein the polyethylene has a melt index of about 3 to about 15 g/10 min (230° C.);
(D) between 0 and 10 parts by weight of thermoplastic elastic rubber; and
(E) between 5 and 30 parts by weight of an inorganic filler, wherein said automobile door trim if formed by molding the resin.

7. The automobile door trim of claim 6, wherein the resin comprises:
(A) between about 20 and about 60 parts by wt of the highly-crystalline polypropylene resin consisting of propylene monopolymer, a copolymer of propylene and less than about 10 mol% of C₂-C₁₀ monomer, or mixture thereof, wherein the isotactic index of the highly-crystalline polypropylene resin is about 99%;
(B) between about 10 and about 50 parts by weight of the partially-crosslinked polypropylene resin, which contains per 100 parts of (B):
(a) between about 20 and about 70 parts by weight of crystalline polypropylene resin, wherein the crystalline polypropylene resin has a weight-average molecular weight larger than 500,000 g/mol.
(b) between about 30 and about 70 parts by weight of copolymer resin propylene and 15 to 25 mol% of C₂ and/or C₄-C₁₀ monomers, and has a melt index of 20 to 60 g/10 min (230 ° C.);
(c) between about 2 and about 8 parts by weight of a crosslinking agent, wherein the crosslinking agent is a polymerizable monomer; and
(d) between about 0.4 and about 1.6 parts by weight of reaction initiator, all with reference to 100 parts by wt of the ingredient (B), wherein the reaction initiator comprises at least one organic peroxide, and wherein the partially-crosslinked polypropylene resin mixture is heated and mixed to have substantially complete reaction of the reaction initiator;
(C) between about 30 and about 70 parts by weight of high-density polyethylene;
(D) between about 0 and about 5 parts by weight of thermoplastic elastic rubber; and
(E) between about 10 and about 20 parts by weight of an inorganic filler.

8. The automobile door trim of claim 6, wherein the highly-crystalline polypropylene resin (A) is present in an amount between about 20 parts and about 60 parts, and the total of the highly-crystalline polypropylene resin (A) and the partially-crosslinked polypropylene resin (B) is between about 65 parts and, about 75 parts by weight.

9. The automobile door trim of claim 7, wherein the crosslinking agent is selected from the group consisting of styrene, α-methylstyrene, methyl methacrylate, ethyl methacrylate, cyclohexyl methacrylate, phenyl methacrylate, benzyl methacrylate, glycidyl methacrylate, methyl acrylate, ethyl acrylate, cyclohexyl acrylate, phenyl acrylate, benzyl acrylate, butyl acrylate, glycidyl acrylate, vinyl acetate, vinyl benzoate, methyl vinyl ether, ethyl vinyl ether, propyl vinyl ether, butyl vinyl ether, or mixture thereof.

10. The automobile door trim of claim 7, wherein the crosslinking agent comprises styrene and/or derivatives thereof, and at least one of acrylate and/or derivatives thereof and methacrylate and/or derivatives thereof.

11. The automobile door trim of claim 7, wherein the reaction initiator comprises benzoyl peroxide, lauryl peroxide, dicumyl peroxide, bis(t-butylperoxyisopropyl)benzene, 2,5-dimethyl-2,5-di(t-butylperoxy)hexane, 2,5-dimethyl-2,5-di(t-butylperoxy)hexane-3, or mixture thereof

12. The automobile door trim of claim 7, wherein the thermoplastic elastomer rubber comprises copolymers of ethylene and one or more C₂-C₁₀ α-olefins.

13. The automobile door trim of claim 7, wherein the thermoplastic elastomer rubber comprises ethylene-octene copolymer having between 10 and 39 weight percent of octene content with a melt index of 0.5 to 8 g/10 min (190° C., 2.6 kgf)

14. The automobile door trim of claim 7, wherein there is less than about 1 part by weight of thermoplastic elastomer rubber.

15. The automobile door trim of claim 7, wherein the inorganic filler comprises talc, calcium carbonate, calcium sulfate, magnesium oxide, calcium stearate, wollastonite, mica, silica, calcium silicate, clay, carbon black, or mixture thereof.

16. The automobile door trim of claim 7, wherein the inorganic filler comprises wollastonite, talc, or mixtures thereof with a particle size of between about 1-30 μm.

17. The automobile door trim of claim 6, wherein the resin contains no thermoplastic elastic rubber.
